(19) United States
(12) Patent Application Publication
(10) Pub. No.: US 2016/0279768 A1
(43) Pub. Date: Sep. 29, 2016

(54) METHOD FOR MANUFACTURING A DRIVER BIT

(71) Applicant: Tuo-Jen Chen, Taichung City (TW)

(72) Inventor: Tuo-Jen Chen, Taichung City (TW)

(21) Appl. No.: 14/667,639

(22) Filed: Mar. 24, 2015

(51) Int. Cl. B25B 15/00; B21K 5/00

(52) U.S. Cl. CPC B25B 15/001; B21K 5/00

(57) ABSTRACT

A method for manufacturing a driver bit with a flat head includes a step of preparing semi-finished product: the semi-finished product being a bar with equal distance between any two adjacent sides, the semi-finished product having an operation end and a connection end and a transition section connected between the operation end and the connection end, the distance between two opposite sides of the transition section being Z1, the distance between two opposite sides of the connection end being Y1, wherein Z1<Y1; a step of flatting: pressing the first and second sides of the connection end to form a first flattened side and a second flattened side, the connection end being flattened to have a height of, wherein Y1≦2X, and Z1≦X, and a step of forming a hole: a hole defined through the first and second flattened sides.

### BACKGROUND OF THE INVENTION

1. Fields of the invention

The present invention relates to a method for manufacturing a driver bit, and more particularly, to a method for manufacturing a driver bit of a bicycle folding tool.

2. Descriptions of Related Art

The conventional method for making a bicycle folding tool is to bending one end of a bar to form a desired shape. The cross section of the bar has a circular cross section or has an even thickness with constant distance between two opposite sides. The function end is cut by using a co-axial lathe which is suitable for mass production to have less cost. However, the bar has to be bent and machined a certain length “L” as shown in FIG. 1 so that the cost for the bars is high, and the volume and weight of the bars are significant.

A known method is to cut or mill an extruded bar, and each bar is drilled a hole to meet the requirement of the driver bit. However, in order to obtain a constant quality of the final products, special extruded rectangular bars with uneven sides are used, the un-even sides make the manufacturing steps be difficult. The small sized driver bits cannot be precisely manufactured because the bar is much larger than the size of the final products.

The blade of the lathe always has one portion thereof suffered by heavy cutting, and the other portion of the blade does not even touch the bar, as shown in FIG. 3, the blade tends to be damaged. In order to protect the blade, the feed of the blade has to be controlled to be slow and short. This obviously prolongs the time required.

One-side cutting makes the driver bit to have uneven structural strength so that the driver bit is easily broken.

The interfering of the installation of the folding tool is not convenient for the user to use, such as, the long bit has to be pivoted away before the short bit is used. A high manufacturing cost is applied to the folding tool.

As shown in FIG. 4, too much material is removed from the connection end of the driver bit so as to reduce the weight, and this weakens the strength of the driver bit. This situation is even worse when the thickness of the connection end of the driver bit, and this is often seen in small sized folding tools. A known method is to press-forge the cylindrical bar to increase the density of the material to overcome the problem. However, this method leaves concentration stress in the bar so that the bar has to be treated with annealing to improve the hardness of the bar, such that the bar can then be flattened and cut.

Although the above mentioned method can have netter structural strength, the annealing process may cause the bar to loose carbon, so that the final product cannot have desired stiffness after being treated by heat-treatment. The method also increases the time required and the manufacturing cost.

FIG. 5 shows that one end of the bar is press to have thinner thickness and then the thinner end is rolled and bent. Nevertheless, the method usually accompanied with high stress in the pressed end, so that the pressed end is easily broken when being bent or rolled.

Besides, the bent or rolled end is not a complete circle and has an opening, so that it cannot bear a large force as shown in FIG. 6.

Therefore, the ideal of the bar should have a circular cross section or an even width to reduce the manufacturing cost. The bar can be deformed elastically properly to increase the density and strength thereof, and limited deformation is applied for the following manufacturing steps.

The hole should be made with a complete circular instead of a C-shaped hole to have better strength. The connection end of the driver bit should not be made by way of bending to reduce its weight and manufacturing cost. The annealing process should be avoided to obtain the carbon in the material, so that the driver bit can have better strength and hardness after being treated with heat treatment.

The present invention intends to provide a method for manufacturing a driver bit of a bicycle folding tool and the method improves the shortcomings mentioned above.

### SUMMARY OF THE INVENTION

The present invention relates to a method for manufacturing a driver bit with a flat head comprises a step of preparing semi-finished product: the semi-finished product being a bar with equal distance between any two adjacent sides, the semi-finished product having an operation end and a connection end and a transition section connected between the operation end and the connection end, the transition section having a first side and a second side located opposite to the first side, a distance Z1 defined between the first and second sides of the transition section, the connection end having a first side and a second side, a distance between the first and second sides of the connection end being Y1, wherein Z1<Y1;

a step of flattening and elastic machining: pressing the first and second sides of the connection end to form a first flattened side and a second flattened side, the connection end being flattened to have a height of, wherein Y1≦2X, and Z1≦X, and

a step of forming a hole: a hole defined through the first and second flattened sides.

Preferably, the step of forming a hole comprises a step of removing surplus material at an end of the connection end 12 by way of pressing and cutting.

Preferably, the step of flattening and elastic machining comprises a step of removing surplus material at an end of the connection end 12 by way of pressing and cutting, a periphery of the connection end 12 is hammered. Alternatively, the present invention provides a method for manufacturing a driver bit with a non-flat head, and the method comprises a step of preparing semi-finished product: the semi-finished product being a bar with equal distance between any two adjacent sides, the semi-finished product having an operation end and a connection end and a transition section connected between the operation end and the connection end, the transition section having a first side and a second side located opposite to the first side, a distance Z2 defined between the first and second sides of the transition section, the connection end having a first side and a second side, a distance between the first and second sides of the connection end being Y, wherein Z2<Y;

a step of flattening and elastic machining: pressing the first and second sides of the connection end to form a first flattened side and a second flattened side, the connection end being flattened to have a height of X, wherein Y≦2X, and Z2≦X, and

a step of forming a hole: a hole defined through the first and second flattened sides.

Preferably, the step of forming a hole comprises a step of removing surplus material at an end of the connection end 12 by way of pressing and cutting.

Preferably, the step of flattening and elastic machining comprises a step of removing surplus material at an end of the connection end 12 by way of pressing and cutting, a periphery of the connection end 12 is hammered.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the conventional method for making a driver bit for a folding tool;

FIG. 2 shows the folding tool with multiple driver bits;

FIG. 3 shows the blade operation status of a conventional method;

FIG. 4 shows a driver bit made by a conventional method;

FIG. 5 shows that an end of a bar is pressed to be thinner;

FIG. 6 shows that the pressed end in FIG. 5 is rolled to be a circle;

FIG. 7 shows the steps of the method of the present invention;

FIG. 8 shows the driver bit of the first step of the method of the present invention;

FIG. 9 shows the size relationship of the driver bit of the first step of the method of the present invention;

FIG. 10 shows the size relationship of the driver bit of the second step of the method of the present invention;

FIG. 11 shows the driver bit of the third step of the method of the present invention;

FIG. 12 shows the driver bit of the first step of the second embodiment of the method of the present invention;

FIG. 13 shows the size relationship of the driver bit of the first step of the second embodiment of the method of the present invention;

FIG. 14 shows the size relationship of the driver bit of the second step of the second embodiment of the method of the present invention;

FIG. 15 shows the driver bit of the third step of the second embodiment of the method of the present invention;

FIG. 16 shows the detailed steps of the step of flattening and elastic machining;

FIG. 17 shows the detailed steps of the step of forming a hole;

FIG. 18 shows the product being treated by removing surplus material at the connection end and forming a hole, and

FIG. 19 shows the product being treated by the step of flattening and elastic machining and removing surplus material at the connection end.

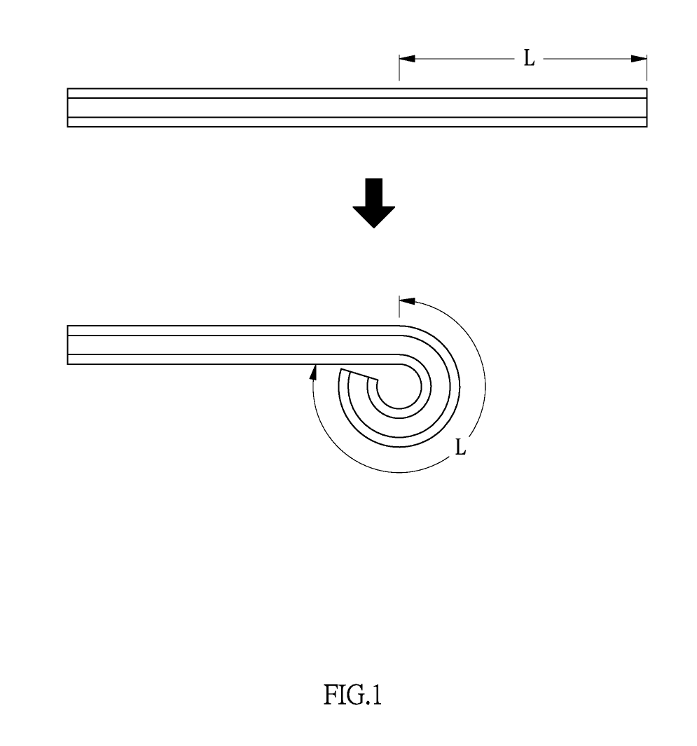

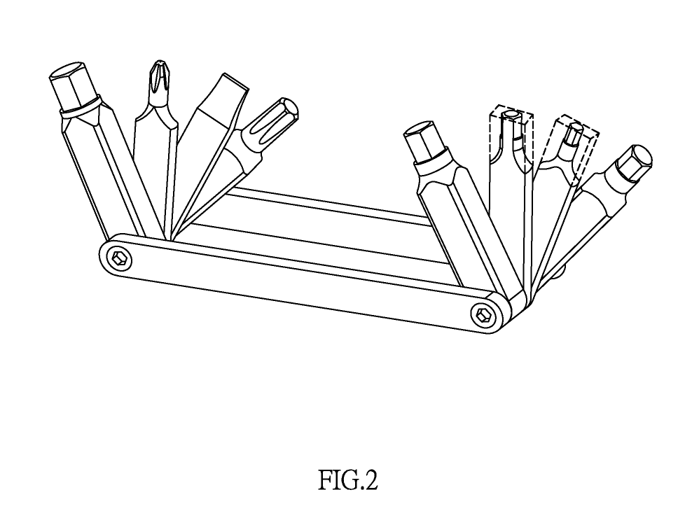

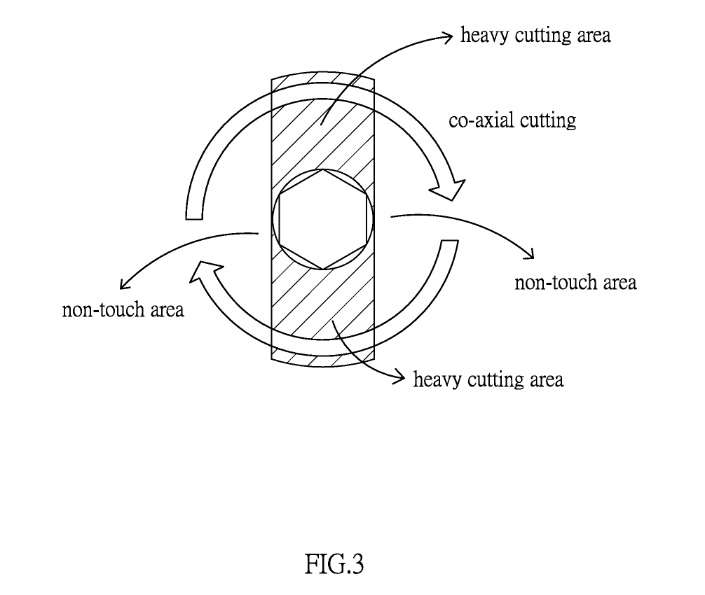

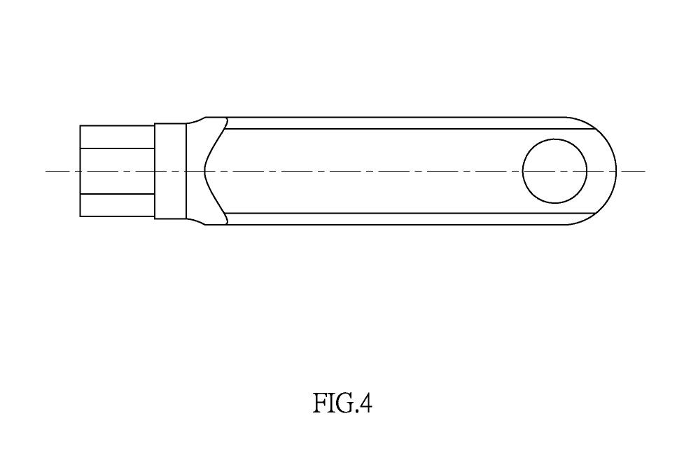

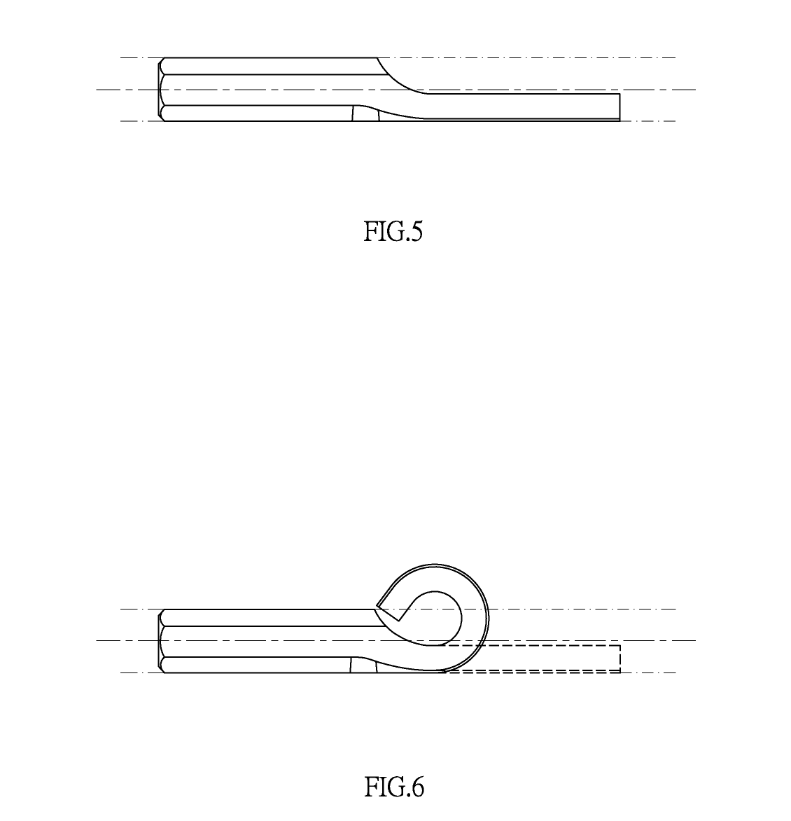

### DETAILED DESCRIPTION OF THE PREFERRED EMBODIMENT

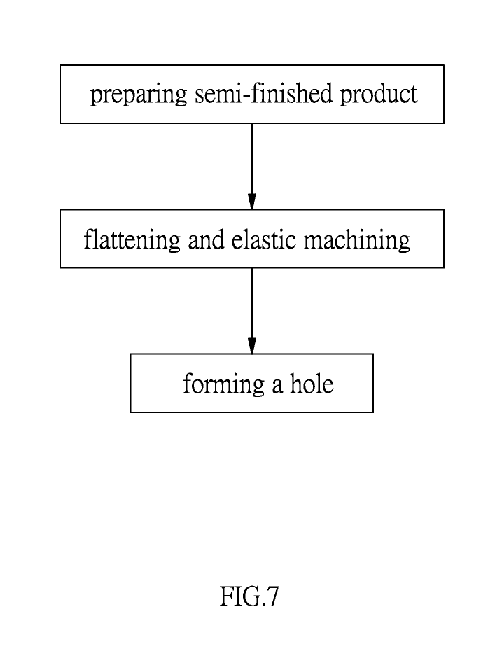

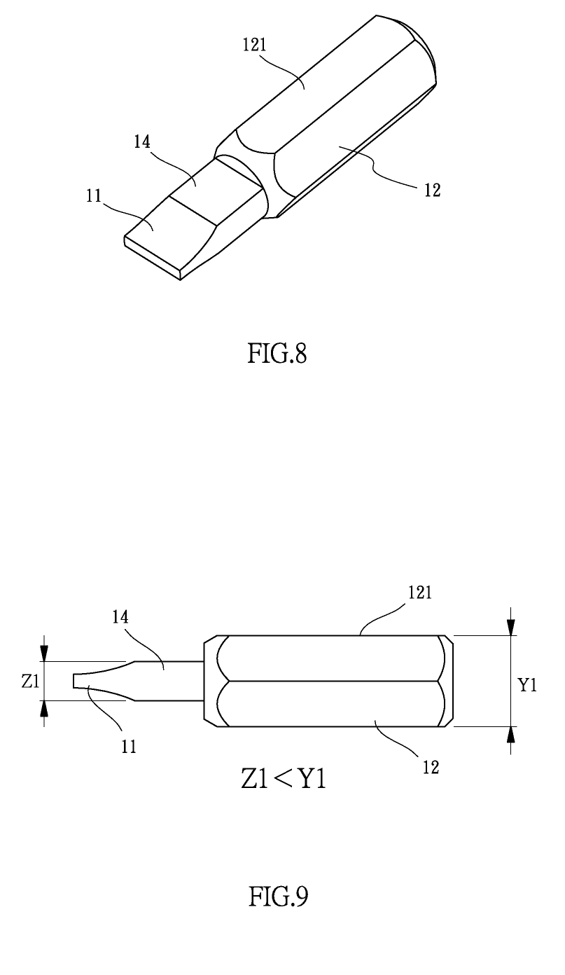

Referring to FIGS. 7 to 9, the first embodiment of the method of the present invention comprises a step of preparing semi-finished product, a step of flattening and elastic machining, and a step of forming a hole.

In the step of preparing semi-finished product, the semi-finished product is a bar with hexagonal, square and circular cross sections, each cross sectional has equal distance between any two adjacent sides, for the circular cross section, the equal distance is the diameter. The semi-finished product has an operation end 11 and a connection end 12, and a transition section 14 connected between the operation end 11 and the connection end 12. The transition section 14 has a first side and a second side located opposite to the first side. The distance Z1 is defined between the first and second sides of the transition section 14. The connection end 12 has a first side and a second side, the distance between the first and second sides of the connection end 12 is Y1, wherein Z1<Y 1.

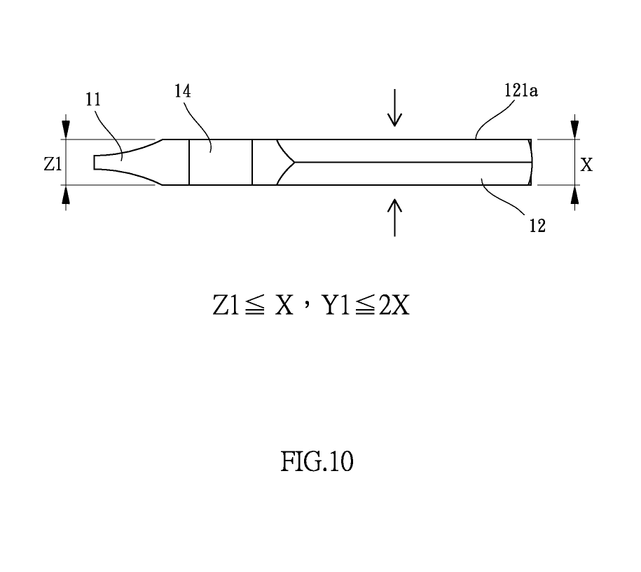

In the step of flattening and elastic machining, the first and second sides of the connection end 12 are hammered and pressed to form a first flattened side 121a and a second flattened side 121b. The connection end 12 is flattened to have a height of X, wherein Y1≦2X, and Z1≦X. The step allows the semi-finished product to be elastically machined without annealing, and the connection end 12 has sufficient strength. When the Z1 X as shown in FIG. 10, the driver bits will not interfere each other when being connected to a folding tool. The connection end 12 and the operation end 11 have suitable strength.

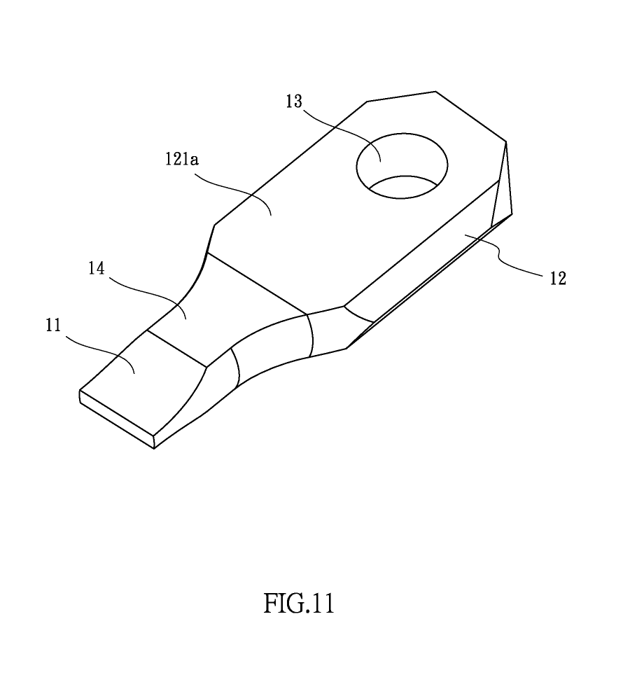

In the step of forming a hole, a hole 13 is defined through the first and second flattened sides 121a, 121b as shown in FIG. 11.

The semi-finished product is a bar with equal distance between any two adjacent sides so that the bar is suitable for co-axially machined in a mass-production scale. The strength is increased and the manufacturing cost is reduced. The operation end 11 can also be machined or made by using specific tools to form a box end or the like. The bars with equal distance between any two adjacent sides or with circular cross section are less expensive in the market. The condition of Y1<2X makes the volume of the bars to be smaller and the connection end 12 is strength enough. The condition Z1<X makes the thickness of the connection end 12 is equal to or smaller than the height of the operation end 11, so that the driver bits are not interfered to each other. The space in transverse direction can be effectively used so that the folding tool is compact and the weight is reduced.

The second embodiment of the method is provided to manufacture a driver bit with a non-flat head, and comprises a step of preparing semi-finished product, a step of flattening and elastic machining, and a step of forming a hole.

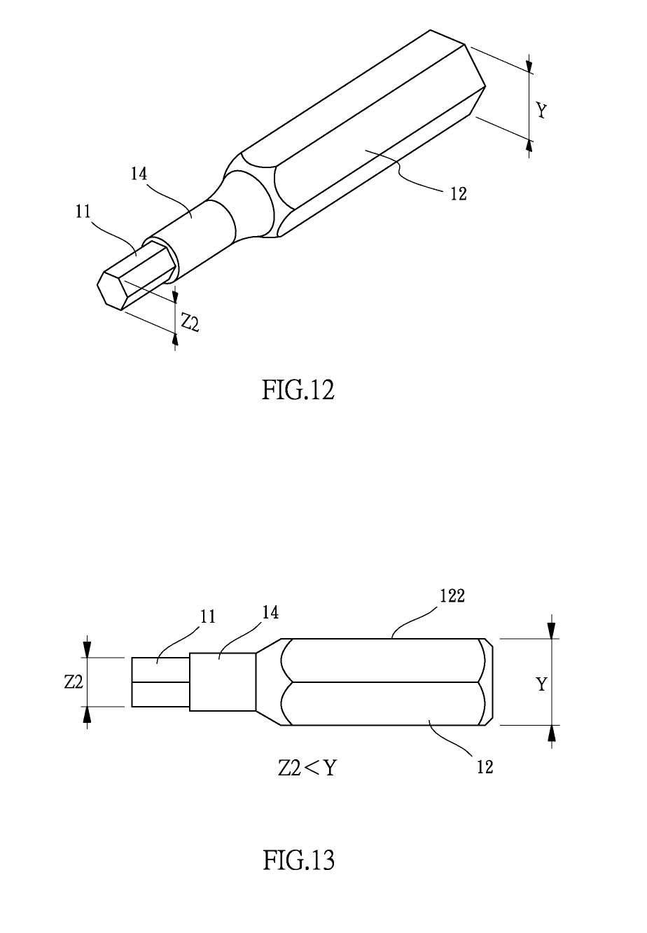

As shown in FIGS. 12 and 13, in the step of preparing semi-finished product, the semi-finished product is a bar with hexagonal, square and circular cross sections, each cross sectional has equal distance between any two adjacent sides, for the circular cross section, the equal distance is the diameter. The semi-finished product has an operation end 11 and a connection end 12, and a transition section 14 connected between the operation end 11 and the connection end 12. The transition section 14 has a first side and a second side located opposite to the first side. The distance Z2 is defined between the first and second sides of the transition section 14. The connection end 12 has a first side and a second side. The distance between the first and second sides of the connection end 12 is Y, wherein Z2<Y.

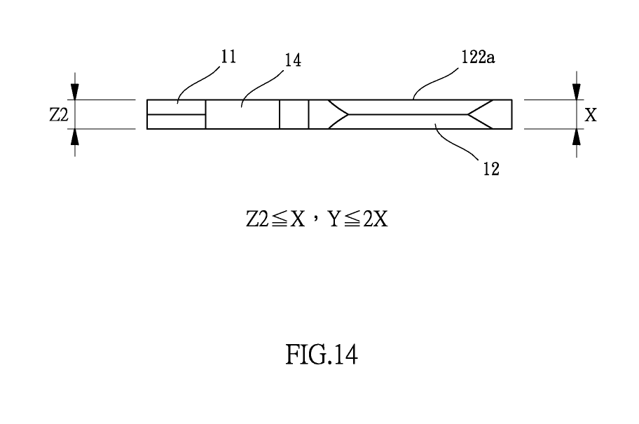

In the step of flattening and elastic machining, the first and second sides of the connection end 12 are hammered and pressed to form a first flattened side 121a and a second flattened side 121b. The connection end 12 flattened has a height of X, wherein Y≦2X, and Z2≦X. When Y≦2X, the semi-finished product can be elastically machined without annealing, and the connection end 12 has sufficient strength. When the Z1≦X as shown in FIG. 14, the driver bits will not interfere each other when being connected to a folding tool. The connection end 12 and the operation end 11 have suitable strength.

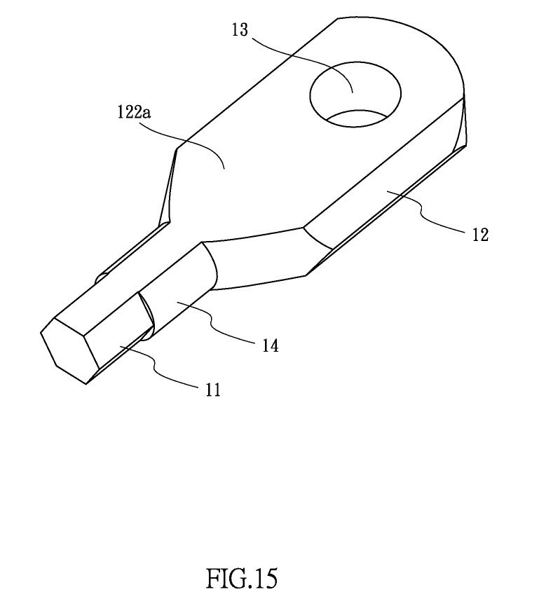

In the step of forming a hole, a hole 13 is defined through the first and second flattened sides 121a, 121b as shown in FIG. 15.

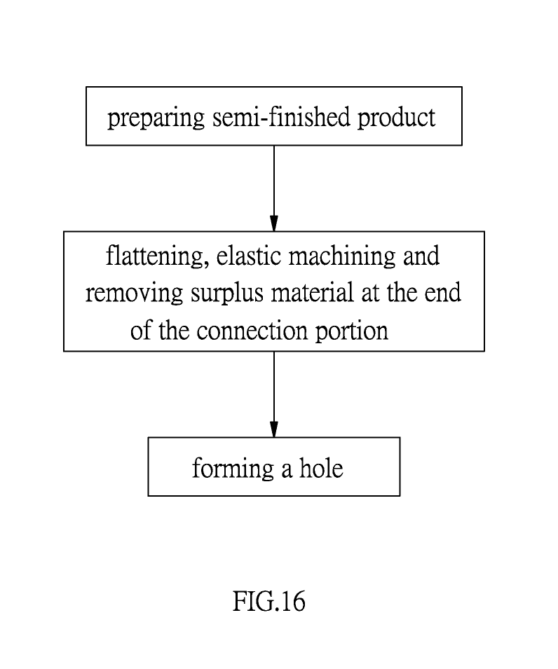

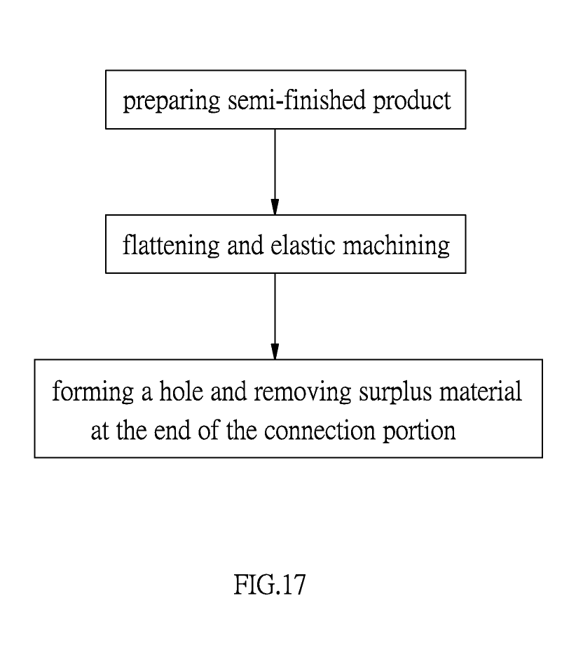

As shown in FIGS. 16 to 17, the step of forming a hole comprises a step of removing surplus material at an end of the connection end 12 by way of pressing and cutting, and the hole 13 is simultaneously defined through the connection end a shown in FIG. 18.

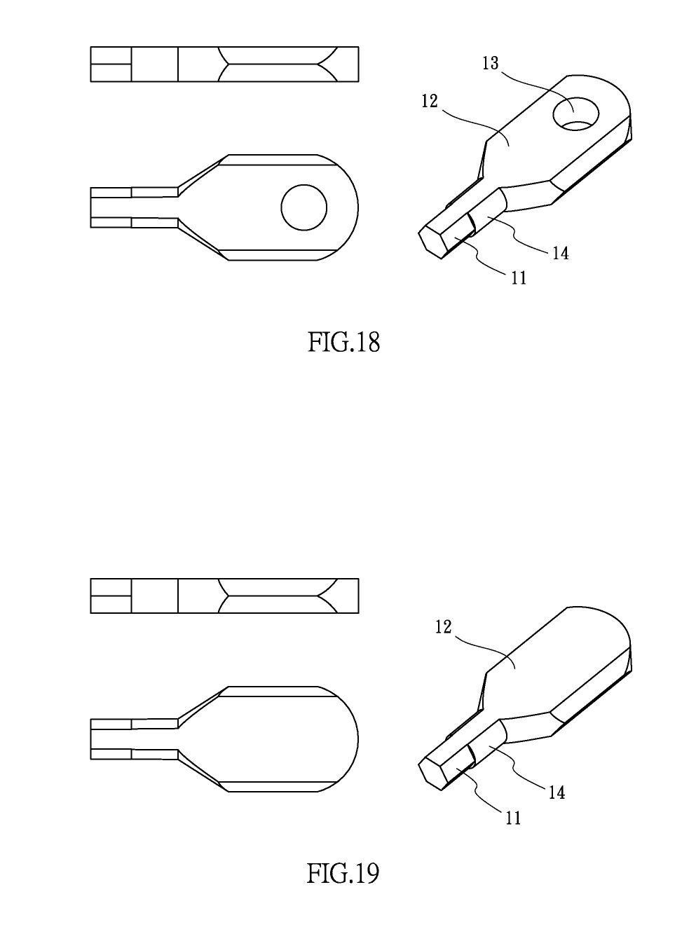

As shown in FIG. 19, the step of flattening and elastic machining comprises a step of removing surplus material at an end of the connection end 12 by way of pressing and cutting, and the periphery of the connection end 12 is simultaneously hammered.

While we have shown and described the embodiment in accordance with the present invention, it should be clear to those skilled in the art that further embodiments may be made without departing from the scope of the present invention.

What is claimed is:

1. A method for manufacturing a driver bit with a flat head, comprising:
a step of preparing semi-finished product: the semi-finished product being a bar with equal distance between any two adjacent sides, the semi-finished product having an operation end and a connection end and a transition section connected between the operation end and the connection end, the transition section having a first side and a second side located opposite to the first side, a distance Z1 defined between the first and second sides of the transition section, the connection end having a first side and a second side, a distance between the first and second sides of the connection end being Y1, wherein Z1<Y1;
a step of flattening and elastic machining: pressing the first and second sides of the connection end to form a first flattened side and a second flattened side, the connection end being flattened to have a height of X, wherein Y1≦2X, and Z1≦X, and
a step of forming a hole: a hole defined through the first and second flattened sides.

2. The method as claimed in claim 1, wherein the step of forming a hole comprises a step of removing surplus material at an end of the connection end by way of pressing and cutting.

3. The method as claimed in claim 1, the step of flattening and elastic machining comprises a step of removing surplus material at an end of the connection end by way of pressing and cutting, a periphery of the connection end is hammered.

4. A method for manufacturing a driver bit with a non-flat head, comprising:
a step of preparing semi-finished product: the semi-finished product being a bar with equal distance between any two adjacent sides, the semi-finished product having an operation end and a connection end and a transition section connected between the operation end and the connection end, the transition section having a first side and a second side located opposite to the first side, a distance Z2 defined between the first and second sides of the transition section, the connection end having a first side and a second side, a distance between the first and second sides of the connection end being Y, wherein Z2<Y;
a step of flattening and elastic machining: pressing the first and second sides of the connection end to form a first flattened side and a second flattened side, the connection end being flattened to have a height of X, wherein Y≦2X, and Z2≦X, and
a step of forming a hole: a hole defined through the first and second flattened sides.

5. The method as claimed in claim 4, wherein the step of forming a hole comprises a step of removing surplus material at an end of the connection end by way of pressing and cutting.

6. The method as claimed in claim 4, the step of flattening and elastic machining comprises a step of removing surplus material at an end of the connection end by way of pressing and cutting, a periphery of the connection end is hammered.
